(19) United States
(12) Patent Application Publication
(10) Pub. No.: US 2009/0218323 A1
(43) Pub. Date: Sep. 3, 2009

(54) Spot welding method, method for judging shape of nugget, spot welding machine and spot welding electrode

(76) Inventors: Hiroshi Abe, Osaka (JP); Takashi Shinmyou, Osaka (JP); Ryo Kikuchi, Osaka (JP)

Correspondence Address: WENDEROTH, LIND & PONACK, L.L.P., 1030 15th Street, N.W.,, Suite 400 East, Washington, DC, 20005-1503, US

(21) Appl. No.: 11/920,634

(22) PCT Filed: Nov. 1, 2006
(86) PCT No.: PCT/JP2006/321841

§ 371 Date: Jan. 26, 2009

(30) Foreign Application Priority Data
Nov. 9, 2005 (JP) 2005-325185
Mar. 20, 2006 (JP) 2006-077391

(51) Int. Cl. B23K 9/32; B23K 11/11; B23K 11/30

(52) U.S. Cl. 219/86.25; 219/91.2; 219/119

(57) ABSTRACT

An electrode whose electrode surface is a substantially convex curved surface and which has at a center portion a recess set at a predetermined depth allowing a welding trace formed on a metal body surface to reach a deepest portion when a nugget is formed in a satisfactory manner by the spot welding is used as at least an electrode for performing the spot welding. The spot welding quality is judged based on a shape of the welding trace formed on the metal body surface by the spot welding in correspondence with the recess.

### FIELD OF THE INVENTION

The present invention relates to a spot welding method, a method of judging nugget formation, a spot welding machine, and a spot welding electrode.

### BACKGROUND OF THE INVENTION

As is known in the art, in spot welding, the quality of spot welding is evaluated on the basis of a nugget diameter. As a specific evaluation method, there is conducted an individual destructive measurement, such as a so-called chisel inspection in which a chisel is press-fitted into a gap between two steel plates spot-welded together to separate the spot-welded portion, measuring the bonded zone including the heat-affected zone, or a cutting inspection in which the spot-welded portion is cut to directly measure the nugget diameter.

As non-destructive measurement techniques related to spot welding, there have been proposed various techniques such as a technique utilizing ultrasonic waves (JP 62-119453 A and JP 04-265854 A), a technique utilizing vibration (JP 09-171007 A), a technique in which a sound wave generated upon irradiation of intermittent light is detected (JP 03-2659 A), and a technique in which a reflection wave of an elastic wave emitted from a welding electrode is detected (JP 04-40359 A). Further, JP 2001-165911 A discloses a technique in which there are used two variables: the diameter of an annular high inductance portion at a nugget peripheral edge of a spot-welded portion measured when a line of magnetic force is passed through the spot-welded portion; and the difference in inductance between the high inductance portion and a low inductance portion at a central portion of the nugget, and each of the variables as an estimate for the nugget diameter is expressed by a discriminant to set a threshold value for judging the property of the nugget diameter.

### Patent Document 1: JP 2001 -165911 A

### SUMMARY OF THE INVENTION

Chisel inspection makes it possible to judge spot welding quality based on the size of the bonded zone including the heat-affected zone for an object that has undergone destructive measurement. However, with chisel inspection, it is impossible to directly evaluate spot welding quality for an object that has not undergone destructive measurement. In recent years, a high tensile steel material has come to be widely used for vehicle bodies or the like to achieve a reduction in weight. However, a portion where a high tensile steel material has been spot-welded is harder than a portion where an ordinary steel plate has been welded, so it is not suited for chisel inspection through a spot check in the production line.

Thus, there is a demand for establishment of a spot welding method allowing quality evaluation of the spot welding through non-destructive inspection. Examples of non-destructive inspection are disclosed in JP 2001-165911 A, etc., and by taking into account the equipment cost and workability, it is desirable to adopt an inspection method which is highly reliable and which allows easier inspection with simpler equipment.

In all of the above-mentioned techniques, spot welding quality is judged after the spot welding. In this regard, no technique has been available which allows judgment of spot welding quality in the spot welding process. If it is possible to control spot welding quality in the spot welding process, the control of a production process using spot welding will be facilitated, and generation of problems in spot welding, such as defective welding, will be reduced.

It is an object of the present invention to provide a spot welding method making it possible to judge spot welding quality through non-destructive inspection and further allowing judgment of spot welding quality more easily with simpler equipment and with higher reliability.

Another object of the present invention is to provide a spot welding method and a spot welding machine allowing control of spot welding quality in the spot welding process.

In a spot welding method according to the present invention, spot welding is performed by using, as at least one electrode for performing spot welding, an electrode whose electrode surface is a substantially convex curved surface and which has at the electrode surface center a recess set at a predetermined depth allowing a welding trace formed on a metal body surface to reach a deepest portion when a nugget is formed in a satisfactory manner by spot welding, spot welding quality being judged based on the configuration of the welding trace formed on the metal body surface by spot welding in correspondence with the recess. Herein, the term nugget refers to a melt-solidified portion generated in the welded portion in lap resistance welding such as spot welding (JIS Z 3001).

Further, a spot welding electrode according to the present invention has an electrode surface which is a substantially convex curved surface and has at an electrode surface center a recess set at a predetermined depth allowing a welding trace formed on a metal body surface to reach a deepest portion when a nugget is formed in a satisfactory manner by spot welding.

Still further, in a spot welding method according to the present invention, spot welding is performed by using, as at least one of a pair of welding electrodes for performing spot welding, a welding electrode whose electrode surface is a substantially convex curved surface and which has at the electrode surface center a recess set at a predetermined depth allowing a welding trace formed on a metal body surface to reach a deepest portion when a nugget is formed in a satisfactory manner by spot welding, the spot welding being judged to be complete when the resistance value at the time of welding attains an equilibrium state. As a method of judging nugget formation, it is also possible to judge a nugget to have been properly formed at the spot-welded portion when an equilibrium state is attained by the resistance value during welding in such spot welding.

Yet further, a spot welding machine according to the present invention performs spot welding by using, as at least one of a pair of welding electrodes for performing the spot welding, a welding electrode whose electrode surface is a substantially convex curved surface and which has at an electrode surface center a recess set at a predetermined depth allowing a welding trace formed on a metal body surface to reach a deepest portion when a nugget is formed in a satisfactory manner by spot welding. The spot welding machine according to the present invention includes a resistance value detecting portion for detecting a resistance value obtained during welding, and a welding control device that judges the spot welding to be complete when the resistance value obtained during welding detected by the resistance value detecting portion attains an equilibrium state.

According to the present invention, spot welding quality is judged based on the configuration of a welding trace formed on the surface of a metal body in correspondence with a recess at the center of the electrode surface of the welding electrode, so it is possible to judge spot welding quality through non-destructive inspection. Further, it is possible to judge spot welding quality more easily with simpler equipment and with higher reliability.

Further, according to the present invention, in the process in which spot welding is performed by using a welding electrode having a recess of a predetermined depth at the electrode surface center, a judgment as to whether a nugget has been properly formed is made based on the resistance value at the time of welding, and further, a spot welding completion judgment is made. Therefore, it is possible to control spot welding quality in the spot welding process. As a result, the control of a production process using spot welding is facilitated, and it is possible to reduce generation of problems in spot welding such as defective welding.

### DETAILED DESCRIPTION OF THE INVENTION

First, a spot welding method and a spot welding electrode according to an embodiment of the present invention will be described with reference to the drawings.

As shown in FIG. 1, of a pair of electrodes 1, 2 for performing spot welding, one electrode 1 has a recess 3 in an electrode surface. When spot welding is performed by using those electrodes, there is formed, as shown in FIGS. 1, 2, a convex welding trace 6 on a surface of steel plates 4, 5 (metal body) in correspondence with the recess 3 formed in the electrode surface of the electrode 1. Focusing attention on the convex welding trace 6, the inventors of the present invention examined the correlation between the height of the convex welding trace 6, the diameter of a nugget 7 (nugget diameter), and tensile shear strength (TSS).

FIG. 3 shows an example of data showing the correlation between the height of the convex portion and the nugget diameter, FIG. 4 shows an example of data showing the correlation between the height of the convex portion and the tensile shear strength (TSS), and FIG. 5 shows an example of data showing the correlation between the nugget diameter and the tensile shear strength (TSS).

Herein, as shown in FIG. 1, of the pair of upper and lower electrodes 1, 2, the upper electrode 1 has the recess 3 in its surface. Further, regarding the electrode 1 having the recess 3, two types of electrode were prepared: one having a cylindrical recess 3 having a diameter of 3 mm; and the other one having a cylindrical recess having a diameter of 5 mm. The correlation diagrams of FIGS. 3 through 5 show data in a case in which the cylindrical recess 3 formed in the surface of the electrode 1 had a diameter of 3 mm and data in a case in which it had a diameter of 5 mm. A pressurizing force of 250 kgf (approximately 2.45 kN) and a pressurizing force of 150 kgf (approximately 1.47 kN) were applied, respectively, the electric current value was varied from 5 kA to 13 kA, and the energization time was varied from 4 cycles to 10 cycles to thereby vary the spot welding energy, preparing specimens differing in the height of the convex portion, the nugget diameter, and the tensile shear strength (TSS). A plurality of specimens were prepared for each of the different conditions. Herein, spot welding is performed by using an AC power source of a frequency of 60 Hz, “cycle” is a unit for setting the energization time, and 1 cycle is 1/60 (seconds).

As a result, as shown in FIGS. 3 through 5, it was found out that there is a correlation between the above factors and that the nugget diameter and the tensile shear strength (TSS) can be estimated from the height of the convex welding trace 6. Based on the above findings, the inventors of the present invention have thought of performing spot welding by using welding electrodes constructed as follows: as shown in FIG. 6(a), of a pair of welding electrodes 10, 20 for performing spot welding, at least one welding electrode 10 (hereinafter referred to as “mark electrode”) has a substantially convex curved electrode surface and has at the center of the electrode surface a recess 12 which is set at a predetermined depth allowing a welding trace 15 formed on the surface of the metal body to reach a deepest portion 16 when a nugget 13 is formed in a satisfactory manner by spot welding.

FIGS. 7(a) and 7(b) shows the mark electrode 10. As described above, the mark electrode 10 has the recess 12 at the center of the electrode surface 11, with the portion of the electrode surface 11 except for the recess 12 being a convex curved surface. The recess 12 formed in the electrode surface 11 of the mark electrode 10 is preferably set, through previous examination or the like, to a predetermined depth allowing the welding trace 15 formed on the surface of the steel plate 14 as the metal body to reach the deepest portion 16 when the nugget 13 is formed in a satisfactory manner by spot welding. In this embodiment, a flat surface 17 is formed at the deepest portion 16 of the recess 12. As shown in FIG. 6(a), at the apex of the welding trace 15, there is formed a flat surface 18 in conformity therewith. The flat surface 18 can be used as a mark making it possible to make sure through visual check or the like that the welding trace 15 has reached the deepest portion 16 of the recess 12 of the mark electrode 10.

In the example shown in FIG. 6(a), spot welding is performed by using the mark electrode 10 as one electrode and an ordinary spot welding electrode 20 as the other electrode, but it is also possible for both of the pair of welding electrodes 10, 20 for spot welding to be constituted of mark electrodes.

As shown in FIG. 6(a), when spot welding is conducted by using the mark electrode 10, there is formed on the surface of the steel plate 14 the convex welding trace 15 in correspondence with the mark electrode 10. Further, the recess 12 formed in the electrode surface 11 of the mark electrode 10 is set at a predetermined depth allowing the welding trace 15 formed on the surface of the steel plate 14 to reach the deepest portion 16 when the nugget 13 is formed in a satisfactory manner by spot welding. Thus, when the nugget 13 formed by spot welding is a deficient one, the welding trace 14 formed on the surface of the steel plate 14 does not reach the deepest portion 16 of the recess 12, as shown in FIG. 6(b). In contrast, when the nugget 13 is formed in a satisfactory manner by spot welding, the welding trace 15 formed on the surface of the steel plate 14 reaches the deepest portion 16 of the recess 12, as shown in FIG. 6(a). The depth of the recess 12 may be set by finding, through previous basic experiment, a proper depth for providing such a function.

The formation of the nugget 13 varies according to conditions, such as the quality of material and thickness of the metal bodies stacked together, the number of metal bodies stacked together, the electrode configuration, the electric current, the energization time, and the pressurizing force. In the basic experiment, spot welding is conducted while varying, for example, the above-mentioned conditions, finding the height of the welding trace 15 when the nugget 7 is formed in a satisfactory manner through individual destructive measurement such as chisel inspection, and the proper depth of the recess 12 to be formed at the center of the electrode surface 11 of the mark electrode 10.

Further, as shown in FIG. 7(a), in this embodiment, the recess 12 formed in the electrode surface 11 of the mark electrode 10 is rounded at an inlet peripheral edge portion thereof, and is smoothly recessed from the electrode surface 11. As a result, during spot welding, the surface of the steel plate 14 is swollen smoothly along the recess 12 of the mark electrode 10, making it possible to prevent expulsion (a phenomenon in which molten metal is scattered) which occurs when the energization area (electrode contact area) is changed abruptly. By thus adopting a structure relatively free from expulsion, it is possible to augment the energizing current value, making it possible to perform spot welding in a satisfactory manner.

As shown in FIG. 6(a), spot welding quality can be judged based on whether the welding trace 15 of a predetermined convex configuration in conformity with the recess 12 of the mark electrode 10 is formed on the surface of the steel plate 14 or not. That is, when the welding trace 15 of a predetermined convex configuration in conformity with the mark electrode 10 is formed on the surface of the steel plate 14, it is determined that a satisfactory nugget 13 has been formed inside the welded steel plate 14, and when the welding trace 15 of a predetermined convex configuration in conformity with the mark electrode 10 is not formed on the surface of the steel plate 14, it is judged that a satisfactory nugget 13 may not have been formed inside the welded steel plate 14.

In this embodiment, as a means for making a judgment as to whether the welding trace 15 of a predetermined convex configuration in conformity with the recess 12 of the mark electrode 10 has been formed or not, there is provided a marker at the deepest portion 16 of the recess 12 of the mark electrode 10. By providing the marker at the deepest portion of the recess 12 of the mark electrode 10, it is possible to judge the quality of spot welding based on whether or not the mark in conformity with the configuration of the marker has been formed at the apex of the welding trace 15, whereby the judgment of the quality of spot welding is facilitated.

For example, in the mark electrode 10 shown in FIGS. 7(a) and 7(b), the flat surface 17 is formed al the deepest portion 16 of the recess 12 as the marker. As shown in FIG. 6(a), in this case, it is possible to judge the quality of spot welding based on whether or not there has been formed the flat surface 18 corresponding to the flat surface 17 as the marker formed in the recess 12 of the mark electrode 10.

Alternatively, as shown in FIG. 8, it is also possible to form a protrusion 21 as the marker at the deepest portion 16 of the recess 12. As shown in FIG. 9, in this case, it is possible to judge the quality of spot welding based on whether or not there has been formed at the apex of the welding trace 15 a recess 22 corresponding to the protrusion 21 as the marker.

Alternatively, as shown in FIG. 10, it is also possible to form a recess 23 as the marker at the deepest portion 16 of the recess 12. As shown in FIG. 11, in this case, it is possible to judge the quality of spot welding based on whether or not there has been formed at the apex of the welding trace 15 a protrusion 24 corresponding to the recess 23 as the marker.

By providing the markers 17, 21, and 23 as shown in FIGS. 7(a), 8, and 10 at the deepest portion 16 of the recess 12 of the mark electrode 10, there are formed at the apex of the welding trace 15 the marks 18, 22, and 24 corresponding to the markers 17, 21, and 23 as shown in FIGS. 6(a), 9, and 11, respectively, whereby the judgment of the quality of spot welding is facilitated. The judgment of the quality of spot welding may be made through visual inspection by an operator or by taking an image of the configuration of the welding trace by an imaging apparatus such as CCD camera and effecting configuration matching through image processing by a computer.

Next, an embodiment carried out by the inventors of the present invention will be described. As shown in FIG. 6(a), the inventors of the present invention stacked together two steel plates 14 of SPC590 and thickness of 1.2 mm, and held them between the pair of upper and lower electrodes 10 and 20, and then pressurized them with a force of 400 kgf and energized them at 16 cycles, examining the relationship between the welding current value and the nugget diameter. Of the pair of upper and lower electrodes 10 and 20, one was the mark electrode 10, and the other was the ordinary electrode 20.

As shown in FIG. 12(b), as the ordinary electrode 20, there was used an electrode having a diameter of 16 mm, the peripheral edge portion of its forward end was formed as a curved surface of R8, and the central portion of its forward end was formed as a curved surface of R15 having a diameter of 10 mm, thus forming an electrode surface 21. As shown in FIG. 12(a), the mark electrode 10 was an electrode having a diameter of 16 mm, the peripheral edge portion of its forward end was formed as a curved surface of R8, and the central portion of its forward end was formed as a curved surface of R15 having a diameter of 10 mm, thus forming the electrode surface 11. In the central portion of the electrode surface 11 of the mark electrode 10, there was formed the recess 12 in a region having a diameter of 6.2 mm. At the deepest portion 16 formed at the center of the recess 12, there was formed the flat surface 17 having a depth of 1.4 mm and a diameter of 2.0 mm as the marker. The portion of the recess 12 from the inlet peripheral edge portion of the recess 12 to the flat surface 17 at the deepest portion 16 is rounded, and the recess as a whole is thus recessed smoothly from the electrode surface 11.

In the examination, under the conditions, spot welding was performed with the welding current value being varied, examining the nugget diameter through individual destructive measurement such as cutting inspection. FIG. 13 shows the relationship between the welding current value and the nugget diameter in the examination. In FIG. 13, the solid plot dots a represent the cases in which the mark in conformity with the marker 17 was not formed at the apex of the welding trace, and the open plot dots b represent the cases in which the mark in conformity with the marker 17 was formed at the apex of the welding trace. In the case of the solid plot dots a, the nugget diameter is small, and the spot welding performed is not to be regarded as satisfactory; in the case of the open plot dots b, the nugget diameter is sufficiently large, and the spot welding performed is to be regarded as satisfactory. The open plot dot c having a star shape represents a case in which expulsion occurred during welding, which is probably attributable to an excessively high welding current value.

Further, in this examination, it was found out that the expulsion generating conditions were mitigated in the case in which spot welding was performed by using the mark electrode 10 for at least one electrode as compared with the case in which both of the pair of upper and lower electrodes used were ordinary electrodes 20. That is, in the mark electrode 10, there is formed at the center of the electrode surface 11 the recess 12 smoothly recessed from the electrode surface 11, so the portion thereof in contact with the surface of the steel plate 14 at the initial stage of energization becomes circular, thus securing a large contact area. When the energization is started and the steel plate 14 is heated and the surface thereof is softened, the contact area increases accordingly. Thus, the generation of expulsion in spot welding can be probably kept at a very low level. When the mark electrode 10 is thus used, expulsion does not easily occur, so it is possible to set the welding current value at a high level, whereby a satisfactory nugget is formed, thereby making it possible to perform spot welding in a satisfactory manner.

The marker formed at the deepest portion of the recess of the mark electrode is not limited to that of the above embodiment, but may adopt some other form.

Next, another embodiment of the present invention will be described. This embodiment differs from the above-mentioned embodiment in that the quality of spot welding can be controlled during the spot welding process.

In the process in which the convex welding trace 15 of a predetermined configuration in conformity with the recess 12 of the mark electrode 10, when spot welding is performed by using the mark electrode 10, the inventors of the present invention effected energization while observing the resistance value during welding; further, they performed sampling for many possible energization timings to examine how the nugget was formed. As a result, the inventors of the present invention have found out that in the process in which the welding trace 15 of a predetermined convex configuration in conformity with the recess 12 of the mark electrode 10 is formed when spot welding is performed by using the mark electrode 10, the resistance value A at the time of welding is, as shown in FIG. 14, gradually reduces in accordance with the passage of the energization time, and when the convex welding trace 15 is formed, the resistance value A tends to attain an equilibrium state afterward. A case where the resistance value A during welding has attained an equilibrium state means, in other words, a state where little change in the resistance value during welding occurs for a fixed period of time. Regardless of the kind and thickness of the steel plate to be welded, this tendency was also to be observed when, as shown in FIG. 15, an examination was conducted in which the energization pattern was varied. In FIGS. 14 and 15, reference symbol A indicates the resistance value during welding, and reference symbol B indicates the value of electric current value supplied to the pair of electrodes at the time of welding. FIG. 14 shows that the electric current value and the energization time are controlled such that the electric current value during the energization time is a fixed value. FIG. 15 shows that the electric current value and the energization time are controlled such that the electric current value during energization time varies in seven stages.

The fact that such a tendency is observed is probably due to the following reason. That is, the welding trace 15 of a predetermined convex configuration in conformity with the recess 12 of the mark electrode 10 is formed when the surface of the steel plate 14 gradually softens upon receiving Joule heat, and the steel plate 14 conforms to the recess 12 of the mark electrode 10. In this regard, in the process in which the steel plate 14 gradually conforms to the recess 12 of the mark electrode 10, probably, the resistance value A during welding is gradually reduced as the contact area between the mark electrode 10 and the steel plate 14 increases. At the stage in which the welding trace 15 of a predetermined convex configuration in conformity with the recess 12 of the mark electrode 10 is formed, the resistance value A during welding probably attains an equilibrium state.

The inventors of the present invention confirmed that in the specimen in which the resistance value A during welding had attained an equilibrium state, the convex welding trace 15 was formed appropriately, and a satisfactory nugget 13 was formed, with spot welding effected in a satisfactory manner. Further, the inventors of the present invention also confirmed that in the specimen in which the resistance value A during welding had not attained an equilibrium state yet, the convex welding trace 15 was not formed properly, with the formation of the nugget 13 being insufficient in some cases. From the examination described above, it is to be judged that when the resistance value A during welding attains an equilibrium state, the welding trace 15 of a predetermined convex configuration in conformity with the recess 12 of the mark electrode 10 has been formed. In some cases, when, after the continuation of the equilibrium state, energization is further effected, expulsion occurs due to excessive energization.

Based on the above-mentioned findings, the inventors of the present invention conducted spot welding by using the mark electrode 10 shown, for example, in FIG. 7, as at least one of the pair of welding electrodes 10, 20 for spot welding, and conceived a spot welding method in which the spot welding is judged to be complete when the resistance value A during welding attains an equilibrium state, and a nugget formation judgment method in which it is determined that the nugget has been properly formed at the spot-welded portion when the resistance value A during welding attains an equilibrium state.

As shown in FIG. 6(a), according to this spot welding method, spot welding is performed by using the mark electrode 10 as at least one of a pair of welding electrodes for spot welding, and the spot welding is judged to be complete when the resistance value A during welding attains an equilibrium state, so it is possible to judge spot welding to be complete, with the welding trace 15 of a predetermined convex configuration properly formed at the position corresponding to the recess 12 of the mark electrode 10. In this way, according to this spot welding method, spot welding completion judgment is made by observing the resistance value A during welding, so it is possible, for example, to perform proper spot welding also on steel plates with individual differences. Further, since the spot welding is judged to be complete when the resistance value A during welding attains an equilibrium, it is also possible to prevent generation of expulsion due to excessive energization.

A case where the resistance value A during welding is attained an equilibrium state means, in other words, a state where little change in resistance value during welding occurs for a fixed period of time; the resistance value A during welding may be judged, for example, from the resistance value between the pair of welding electrodes 10, 20 for performing spot welding. If the resistance value A is judged to have attained an equilibrium state, it does not mean that it is strictly maintained at a fixed value. When the resistance value A is judged to have attained an equilibrium state, it is to be assumed that the resistance value A is maintained in a small fixed variation width. The variation width of the resistance value A allowing the resistance value A to be judged to have attained an equilibrium state differs depending upon the kind and thickness of the steel plate to be welded. Thus, as to the variation in the resistance value A allowing the resistance value A to be judged to have attained an equilibrium state, it is desirable to provide an appropriate standard according to the kind and thickness of the steel plate to be welded. Further, in order to prevent generation of expulsion due to excessive energization, also regarding the length of the maintained period of time during which substantially no change in the resistance value A during welding occurs that would allow the resistance value A during welding to be judged to have attained an equilibrium state, it is desirable to provide a proper standard according to the kind and thickness of the steel plate to be welded. For this purpose, through previous examination, an appropriate standard for judging the resistance value A to have attained an equilibrium state is desirable to be determined.

Further, as shown in FIG. 6(a), in an embodiment of a spot welding machine 30 for carrying out the above spot welding method, the mark electrode 10 is used as at least one of the pair of welding electrodes 10, 20 for spot welding, and there may be provided a resistance value detecting portion 31 for detecting the resistance value A during welding, and a welding control device 32 for judging completion of the spot welding when the resistance value A during welding detected by the resistance value detecting portion 31 attains an equilibrium state. As the resistance value detecting portion 31, it is desirable to use a device allowing observation of the resistance value between the pair of welding electrodes 10, 20 for spot welding, e.g., a timer contactor. The welding control device 32 may be equipped, for example, with a judging portion for judging completion of spot welding when the resistance value A during welding detected by the resistance value detecting portion 31 attains an equilibrium state. Further, in order to perform spot welding completion processing based on the spot welding completion judgment, it is desirable to use a control device adapted to transmit a control signal to an energizing device 33 for energizing the pair of welding electrodes 10, 20 for spot welding to thereby control the energization by the energizing device 33.

According to the spot welding machine 30, the resistance value detecting portion 31 detects the resistance value A during welding, and the welding control device 32 completes the spot welding when the resistance value A during welding detected by the resistance value detecting portion 31 attains an equilibrium state. Thus, it is possible to automatically complete the energization, thus making it also possible to omit the setting of the energization time. That is, according to the spot welding machine 30, the setting of the energization time is not effected; instead, an energization pattern (a change in electric current value over time during energization) is set beforehand, whereby if, when the spot welding is judged to be complete during energization, the processing for automatically completing the spot welding is performed, it is possible to effect proper spot welding from processing. As a result, it is possible to reduce the requisite effort for setting the spot welding conditions. Further, according to the individual difference of the steel plate to be spot-welded, the spot welding is completed when the resistance value A during welding detected by the resistance value detecting portion 31 attains an equilibrium state, so it is possible to perform proper spot welding if, for example, the steel plate 14 exhibits an individual difference, thereby facilitating the maintenance of a fixed spot welding quality.

When the resistance value A during welding attains an equilibrium state, the welding trace 15 of a predetermined convex configuration has been properly formed at the position corresponding to the recess 12 of the mark electrode 10, so a nugget is to be judged to have been properly formed at the spot-welded portion. Thus, as the nugget formation judgment method, it is possible to judge a nugget to have been properly formed at the spot-welded portion when the resistance value A during welding attains an equilibrium state. According to this nugget formation judgment method, it is possible to judge a nugget to have been properly formed during spot welding.

As described above, in this embodiment, the judgment as to whether the welding trace 15 of a predetermined convex configuration in conformity with the recess 12 of the mark electrode 10 has been formed or not is made based on the resistance value A during welding in the spot welding process, so it is not necessary to provide the marker 17, 21, or 23 as shown in FIGS. 7(a), 8, or 10, respectively, at the deepest portion 16 of the recess 12 of the mark electrode 10.

Descriptions of the embodiments of the present invention has been made. However, the present invention is not limited to the embodiment described above. For example, as the spot welding of the present invention, it is possible to adopt various types of spot welding, such as direct spot welding, indirect spot welding, or series spot welding.

### BRIEF DESCRIPTION OF THE DRAWINGS

FIG. 1 A schematic view of a basic experiment in which spot welding is performed by using an electrode whose electrode surface has a recess.

FIG. 2 A longitudinal sectional view of a convex welding trace.

FIG. 3 A diagram showing an example of the correlation between the height of a convex portion formed by spot welding and a nugget diameter.

FIG. 4 A diagram showing an example of the correlation between the height of a convex portion formed by spot welding and a tensile shear strength (TSS).

FIG. 5 A diagram showing an example of the correlation between a nugget diameter and a tensile shear strength (TSS).

FIG. 6(a) is a diagram showing bow a convex welding trace is formed by spot welding; and FIG. 6(b) is a diagram showing the process in which the convex welding trace is formed by spot welding.

FIG. 7(a) is a partial longitudinal sectional view of a spot welding electrode according to an embodiment of the present invention; and FIG. 7(b) is showing a bottom view thereof.

FIG. 8 A partial longitudinal sectional view of a spot welding electrode according to another embodiment of the present invention.

FIG. 9 A longitudinal sectional view of a convex welding trace formed by using the spot welding electrode shown in FIG. 8.

FIG. 10 A partial longitudinal sectional view of a spot welding electrode according to another embodiment of the present invention.

FIG. 11 A longitudinal sectional view of a convex welding trace formed by using the spot welding electrode shown in FIG. 10.

FIG. 12 Longitudinal sectional views of a pair of upper and lower electrodes used in an examination in an embodiment, of which FIG. 12(a) shows a mark electrode, and FIG. 12(b) shows on ordinary electrode.

FIG. 13 A diagram showing the relationship between a welding current value and a nugget diameter obtained in an examination in an embodiment.

FIG. 14 A diagram showing resistance value during welding.

FIG. 15 A diagram showing resistance value during welding.

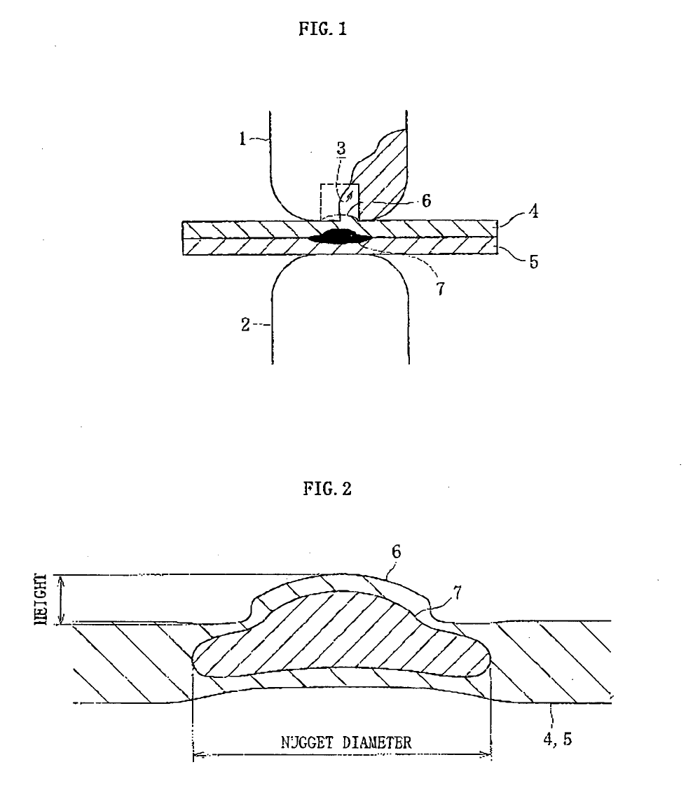

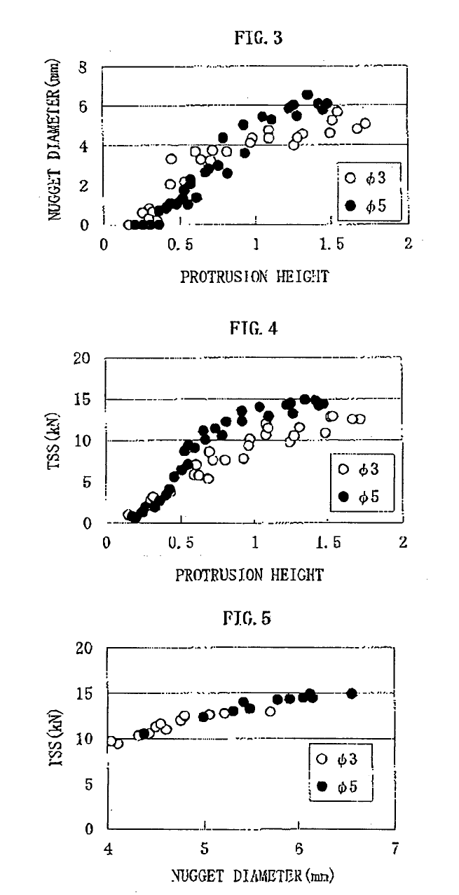

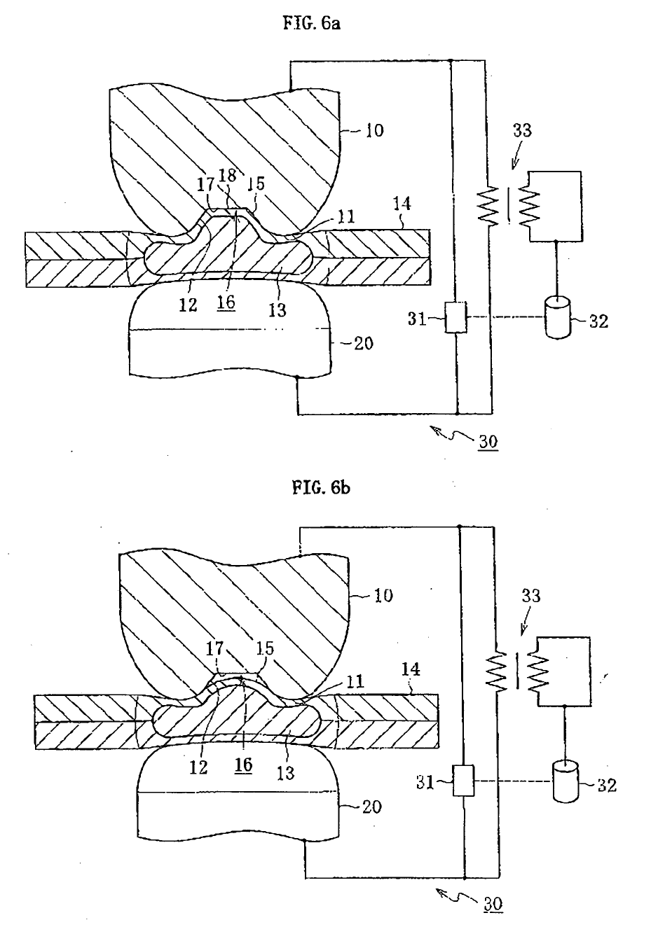

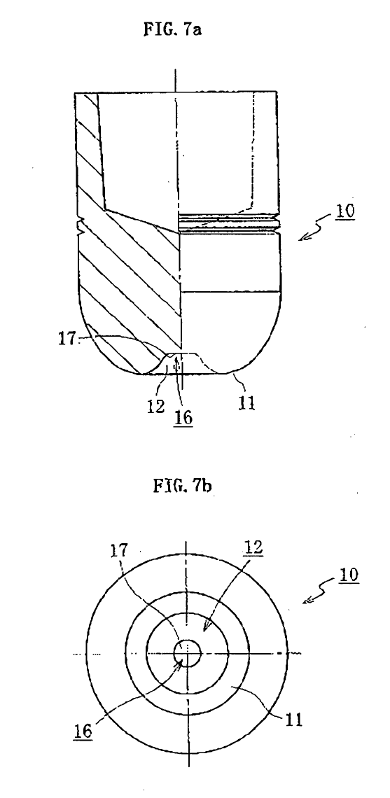

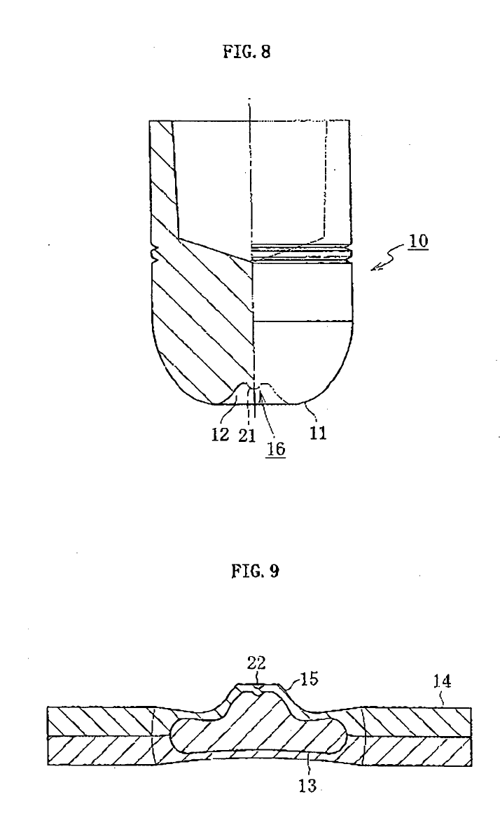

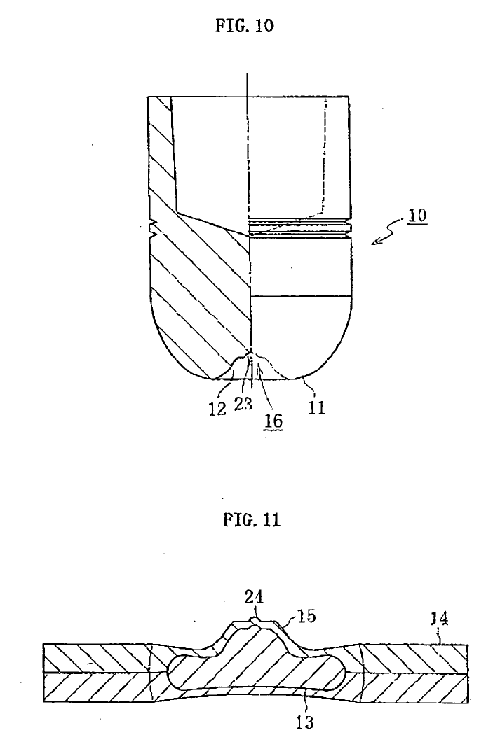

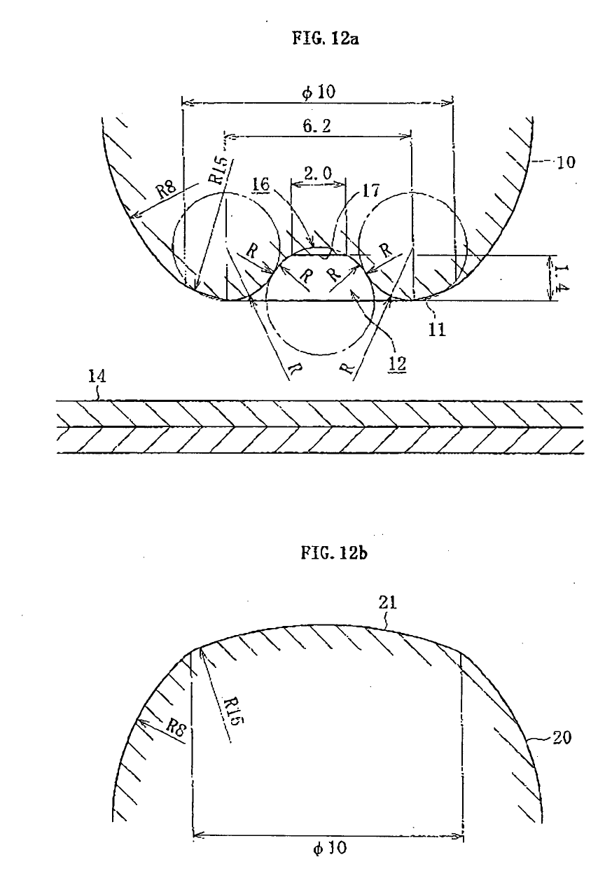

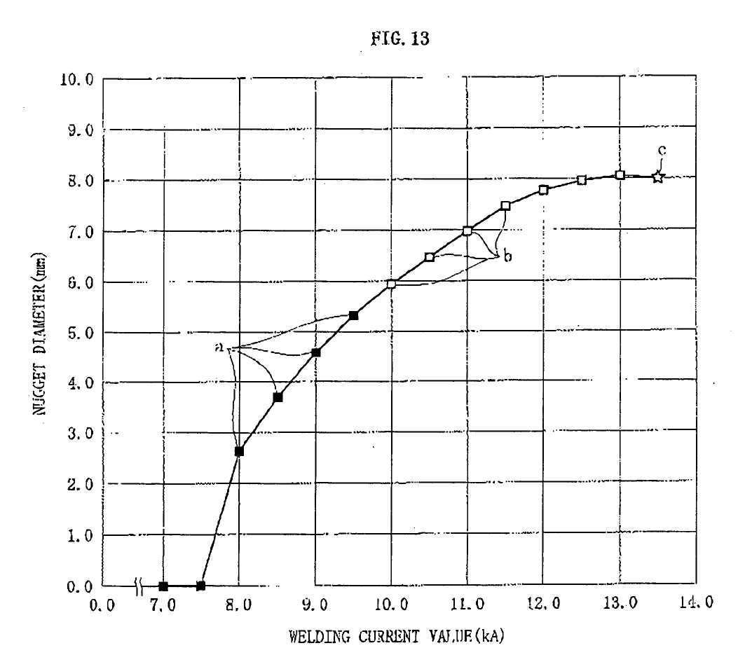

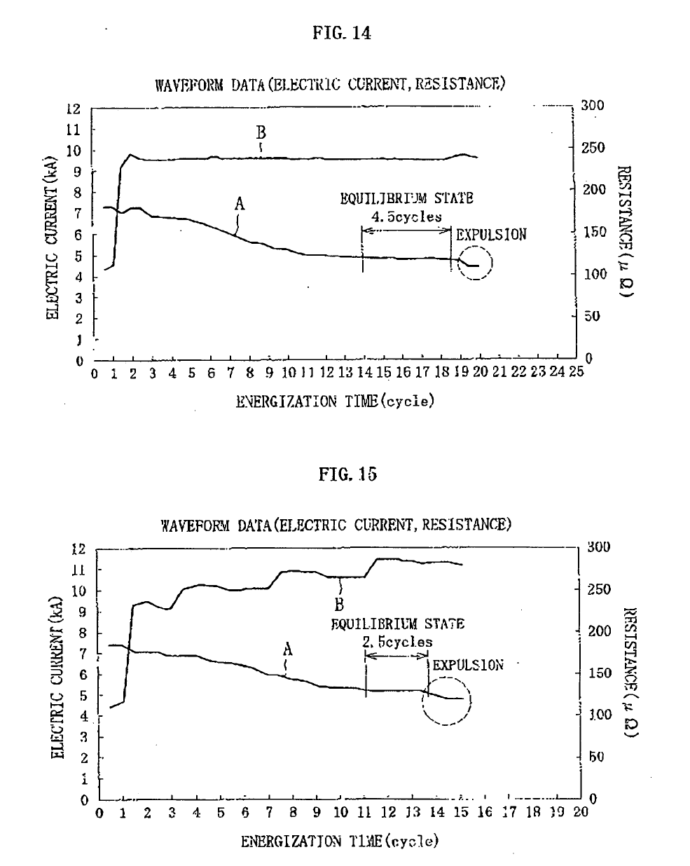

### EXPLANATION OF REFERENCES

10 spot welding electrodes (mark electrode)

11 electrode surface

12 recess

13 nugget

14 steel plate (metal body)

15 welding trace

16 deepest portion

17 flat surface of the deepest portion (marker)

18 flat surface of the welding trace (mark)

20 spot welding electrode

21 convex portion (marker)

22 recess portion (mark)

23 recess portion (marker)

24 convex portion (mark)

30 spot welding machine

31 resistance value detecting portion

32 welding control device

33 energizing device

1. A spot welding method comprising:
performing spot welding by using, as at least one electrode for performing spot welding, an electrode whose electrode surface is a substantially convex curved surface and which has at an electrode surface center a recess set at a predetermined depth allowing a welding trace formed on a metal body surface to reach a deepest portion when a nugget is formed in a satisfactory manner by the spot welding; and
judging a spot welding quality based on a configuration of the welding trace formed on the metal body surface by the spot welding in correspondence with the recess.

2. The spot welding method according to claim 1, wherein a marker is formed at the deepest portion of the recess formed at the electrode surface center of the at least one electrode; and
the spot welding quality is judged based on whether a mark corresponding to the marker is formed at an apex of the welding trace or not.

3. A spot welding electrode, comprising an electrode surface formed in a substantially convex curved surface and having at an electrode surface center a recess set at a predetermined depth allowing a welding trace formed on a metal body surface to reach a deepest portion when a nugget is formed in a satisfactory manner by spot welding.

4. The spot welding electrode according to claim 3, wherein further comprising a marker provided at the deepest portion of the recess.

5. The spot welding electrode according to claim 4, wherein the marker is formed as a flat surface.

6. The spot welding electrode according to claim 3, wherein the recess formed in the electrode surface is rounded at a peripheral edge portion thereof and is smoothly recessed from the electrode surface.

7. A method of judging nugget formation comprising:
performing spot welding by using, as at least one of a pair of welding electrodes for performing the spot welding, a welding electrode whose electrode surface is a substantially convex curved surface and which has at an electrode surface center a recess set at a predetermined depth allowing a welding trace formed on a metal body surface to reach a deepest portion when a nugget is formed in a satisfactory manner by the spot welding and;
judging the nugget to have been properly formed when a resistance value obtained during welding attains an equilibrium state.

8. A spot welding method comprising:
performing spot welding by using, as at least one of a pair of welding electrodes for performing the spot welding, a welding electrode whose electrode surface is a substantially convex curved surface and which has at an electrode surface center a recess set at a predetermined depth allowing a welding trace formed on a metal body surface to reach a deepest portion when a nugget is formed in a satisfactory manner by the spot welding; and
judging the spot welding to have been completed when a resistance value obtained during welding attains an equilibrium state.

9. A spot welding machine comprising:
a pair of welding electrodes for performing the spot welding, at least one of which has an electrode surface being a substantially convex curved surface and having at an electrode surface center a recess set at a predetermined depth allowing a welding trace formed on a metal body surface to reach a deepest portion when a nugget is formed in a satisfactory manner by the spot welding,
a resistance value detecting portion for detecting a resistance value obtained during welding; and
a welding control device that judges the spot welding to be complete when the resistance value obtained during welding detected by the resistance value detecting portion attains an equilibrium state.
